(19) United States
(12) Patent Application Publication
(10) Pub. No.: US 2025/0312245 A1
(43) Pub. Date: Oct. 9, 2025

(54) Pacifier

(71) Applicant: Zolizz, LLC, Erda, UT (US)

(72) Inventors: Sesami Hansen, Erda, UT (US); Jed H. Hansen, Erda, UT (US); Brandon Van Tassell, Erda, UT (US)

(21) Appl. No.: 19/093,690

(22) Filed: Mar. 28, 2025

Related U.S. Application Data
(60) Provisional application No. 63/574,517, filed on Apr. 4, 2024.

(51) Int. Cl. A61J 17/00

(52) U.S. Cl. CPC A61J 17/001; A61J 17/105; A61J 17/109; A61J 17/111

(57) ABSTRACT

A pacifier is disclosed having a guard with a nipple disposed about center of the guard extending downward from a bottom of the guard. The guard has a plurality of wings extending outward from a elongate handle disposed about a center of the guard. The elongate handle forms a protrusion extending upward from the guard.

PRIORITY CLAIM

The Present application claims priority to U.S. Ser. No. 63/574,517 filed Apr. 4, 2024 entitled “PACIFIER” which is incorporated herein by reference in its entirety.

### BACKGROUND

A pacifier generally comprises a nipple coupled to a guard or shield. The nipple is inserted into the mouth of the baby (or any other user) while the guard or shield rests against the mouth of the user. It is desirable to have a pacifier that has a more realistic appearance to the object it exemplifies. Other benefits and advantages of the existing technology are further described herein.

### BRIEF DESCRIPTION OF THE DRAWINGS

Invention embodiments will become more fully apparent from the following description and appended claims, taken in conjunction with the accompanying drawings. It is to be understood that these drawings merely depict exemplary invention embodiments and are not to be considered limiting of the disclosure's scope. It will be readily appreciated that the components of the embodiments, as generally described and illustrated in the figures herein, could be arranged and designed in a wide variety of different configurations. Nonetheless, the technology will be described and explained with additional specificity and detail through the use of the accompanying drawings in which:

FIG. 1 is a perspective view of a pacifier in accordance with one aspect of the technology;

FIG. 2 is a top view of a pacifier in accordance with one aspect of the technology;

FIG. 3 is a bottom view of a pacifier in accordance with one aspect of the technology;

FIG. 4 is side view of a pacifier in accordance with one aspect of the technology;

FIG. 5 is side view of a pacifier in accordance with one aspect of the technology;

FIG. 6 is front view of a pacifier in accordance with one aspect of the technology;

FIG. 7 is back view of a pacifier in accordance with one aspect of the technology;

FIG. 8 is a perspective view of a pacifier in accordance with one aspect of the technology;

FIG. 9 is a perspective view of a pacifier in accordance with one aspect of the technology;

FIG. 10A is a side view of a nipple in accordance with one aspect of the technology;

FIG. 10B is a side view of another nipple in accordance with one aspect of the technology;

FIG. 10C is a side view of a nipple in accordance with one aspect of the technology;

FIG. 10D is a side view of a nipple in accordance with one aspect of the technology;

FIG. 11 is a top perspective view of a pacifier guard in accordance with one aspect of the technology;

FIG. 12 is a bottom view of a pacifier guard in accordance with one aspect of the technology;

FIG. 13 is a top view of a handle assembly in accordance with one aspect of the technology;

FIG. 14 is a side perspective view of a handle assembly in accordance with one aspect of the technology;

FIG. 15 is a cross-sectional view of a pacifier in accordance with one aspect of the technology;

FIG. 16 is a view of a pacifier handle assembly in accordance with one aspect of the technology;

FIG. 17 is a view of a pacifier handle assembly in accordance with one aspect of the technology;

FIG. 18 is a view of a pacifier package and pacifier in accordance with one aspect of the technology;

FIGS. 19A-19I are top views of a plurality of pacifier designs in accordance with one aspect of the technology.

### DESCRIPTION OF ASPECTS OF THE TECHNOLOGY

The following detailed description includes reference to the accompanying drawings, which form a part hereof and in which are shown, by way of illustration, exemplary embodiments. It is believed that the construction and design of pacifiers will improve the aesthetic appeal and performance of the device. However, before the present technology is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Although the following detailed description contains many specifics for the purpose of illustration, a person of ordinary skill in the art will appreciate that many variations and alterations to the following details can be made and are considered to be included herein.

Accordingly, the following embodiments are set forth without any loss of generality to, and without imposing limitations upon, any claims set forth. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a line” includes a plurality of such lines.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open-ended term, like “comprising” or “including,” in this specification it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

Objects described herein as being “adjacent to” each other may be in physical contact with each other, in close proximity to each other, or in the same general region or area as each other, as appropriate for the context in which the phrase is used.

Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context.

However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.8, 3, 3.1, 4, 4.6, and 5, individually.

This same principle applies to ranges reciting only one numerical value as a minimum or a maximum. Furthermore, such an interpretation should apply regardless of the breadth of the range or the characteristics being described.

As used herein, “enhanced,” “improved,” “performance-enhanced,” “upgraded,” “improvement,” and the like, when used in connection with the description of a device, component, or process, refers to a characteristic of the device, component or process that provides measurably better form, function, or outcome as compared to previously known devices or processes. This applies both to the form and function of individual components in a device or process, as well as to such devices or processes as a whole.

Reference throughout this specification to “an example” means that a particular feature, structure, or characteristic described in connection with the example is included in at least one embodiment. Thus, appearances of the phrase “in an example” in various places throughout this specification are not necessarily all referring to the same embodiment.

### Example Embodiments

It should be understood that the aspects of the technology discussed herein are contemplated for use with an infant pacifier or teething apparatus. For purposes of illustrating the various aspects of the methods and systems claimed herein, the discussion below will be primarily directed to describing exemplary embodiments directed to a pacifier with structural elements that imbue the product with aesthetic appeal that is lacking in current pacifiers. It should be noted, however, that the elements and principles discussed herein are applicable to other applications. It is also noted that discussion of methods and systems herein can be interchangeable with respect to specific aspects. In other words, specific discussion of one apparatus, method, or system (or components thereof) herein is equally applicable to other aspects as they relate to the apparatus, system, or method, and vice versa.

An initial overview of aspects of the technology is provided below and specific technology aspects are then described in further detail. This initial summary is intended to aid readers in understanding the technology more quickly but is not intended to identify key or essential technological features, nor is it intended to limit the scope of the claimed subject matter. In particular, aspects of the technology are directed towards a pacifier having a nipple, a guard, and a handle.

In one aspect, the pacifier comprises a nipple retained about a guard (or shield), the guard or shield comprises a top portion and a bottom portion and an elongate handle.

In one aspect, a nipple is disposed and retained within the guard and extends downward from a bottom of the guard. The nipple is held inside the mouth of the infant and the guard rests on the outside of the mouth of the infant. The guard comprises a plurality of opposing wings extending outward from a handle. The wings comprise a curved upper portion and a curved bottom portion. The curved upper portion has a width that is greater than the curved bottom portion. In one aspect, the handle is disposed between opposing wings and comprises a longitudinal protrusion extending from about a top portion of the guard to about a bottom portion of the guard.

In one aspect, the top portion comprises opposing distal ends defining a maximum length of the top portion about a longitudinal length of the upper portion of the guard. The bottom portion comprises opposing distal ends defining a maximum length of the bottom portion. The maximum length of the top portion is greater than the maximum length of the bottom portion. The handle extends the height of the pacifier and is disposed about its middle or a center line. Meaning, it extends from near a top of the top portion to near a bottom of the bottom portion (ranging from 0.75 to 1.25 inches, for example), though it can extend beyond the top portion and/or beyond the bottom portion in other aspects. In another aspect, it can extend different heights across the guard as suits a particular purpose. For example, in one aspect, the handle extends ¼ of the height of the guard (i.e., ¼ from top to bottom about the middle), ⅓ of the height, ½ of the height, ⅔, or ¾ of the height.

The handle itself, in one aspect, has a height and width intended to mimic the body of a butterfly. However, in other aspects, the width of the handle is relatively thin (0.1 to 0.2 inches, for example) yet protrudes (i.e. or has a height) from the face of the guard, in a direction parallel with the direction that the nipple extends downward, a sufficient distance to permit a user to grab the pacifier. In one aspect, the handle protrudes (i.e., it has a height) that extends from about 0.25 to 0.5 inches above the face of the guard.

In one aspect, the handle comprises a longitudinal length that is normal to an axis extending from opposing distal ends of the top portion, though it can also extend in a direction that is parallel to the axis extending from opposing distal ends of the top portion. In this aspect, the handle is disposed about the guard near the top, middle, or bottom, or any other location. Elongate handles have been referenced, but it is understood that curvilinear handles are also contemplated for use herein.

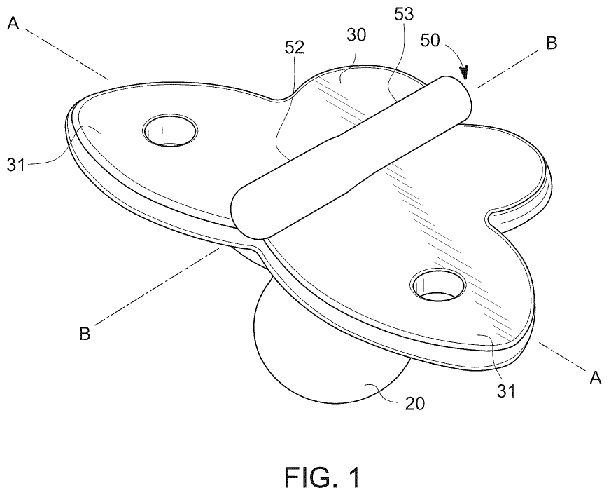

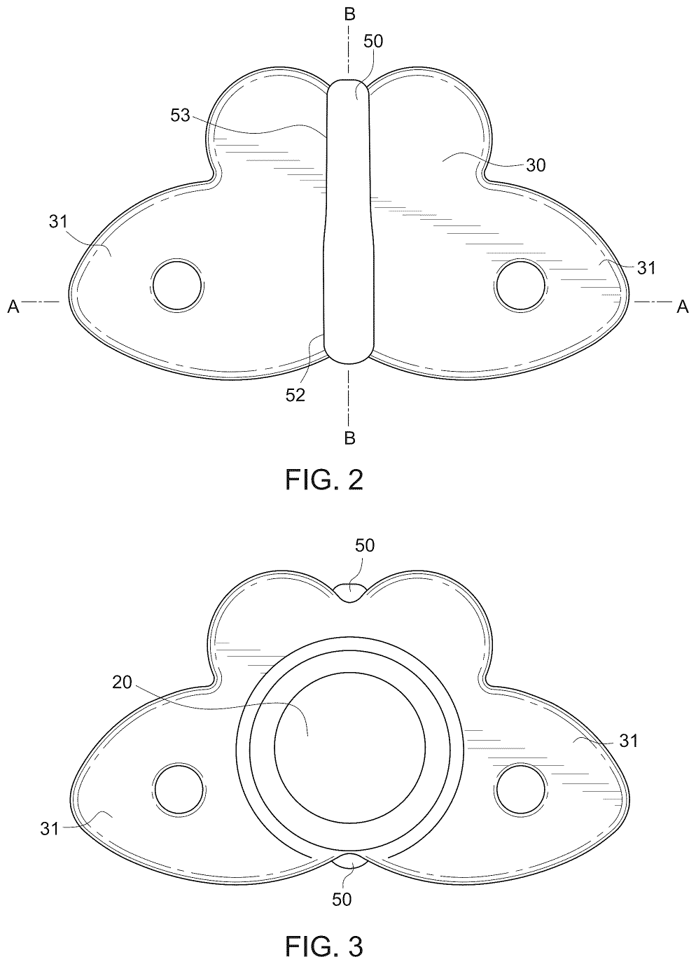

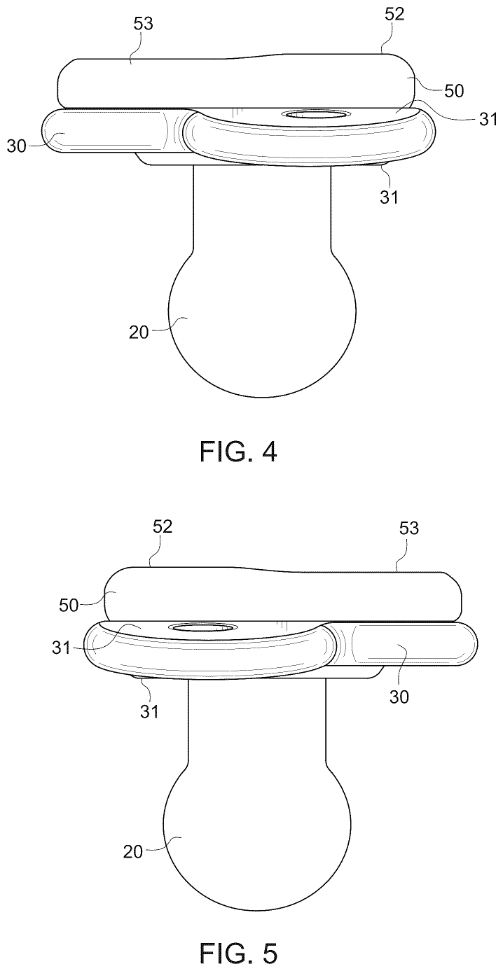

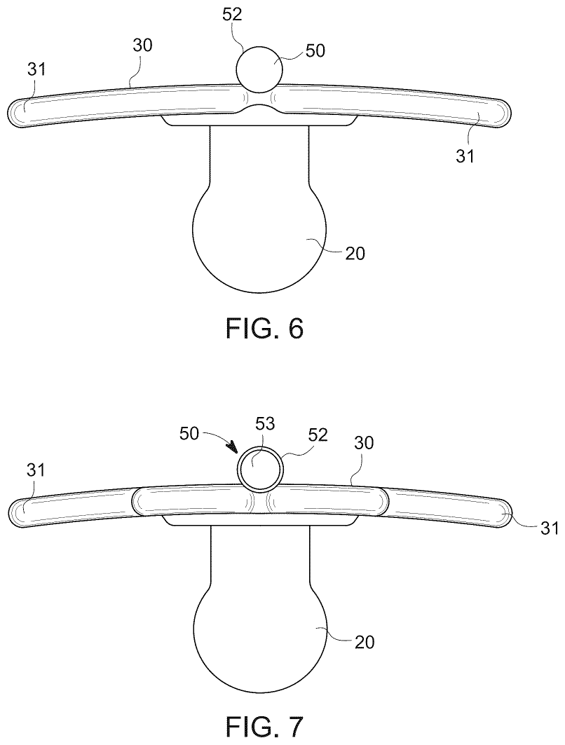

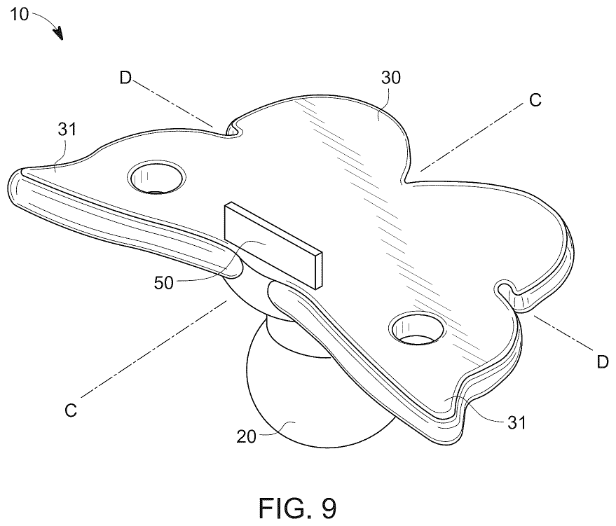

Referring generally to FIGS. 1-9, a pacifier 10 is disclosed having a nipple 20 extending downward from the guard 30 or shield of the pacifier 10. The guard 30 is shaped to approximate a butterfly and has a plurality of opposing wings 31 that extend outward from the butterfly body. In one aspect, the opposing wings can be used as a handle to grasp the pacifier 10. However, in another aspect, an elongate handle 50 is disposed about the middle of the guard 30. In one aspect, the elongate handle 50 comprises a longitudinal protrusion that extends upward from the guard 30. The handle 50 extends in a direction that is normal or perpendicular to the longitudinal length A-A of the guard 30 mimicking the body of a butterfly. That is, the handle 50 is oriented parallel with the height of the guard along B-B.

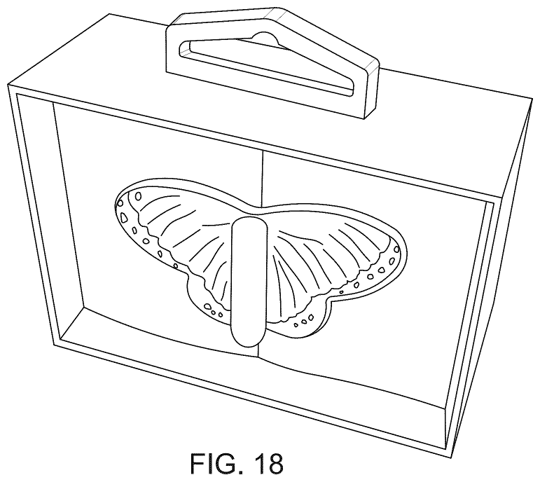

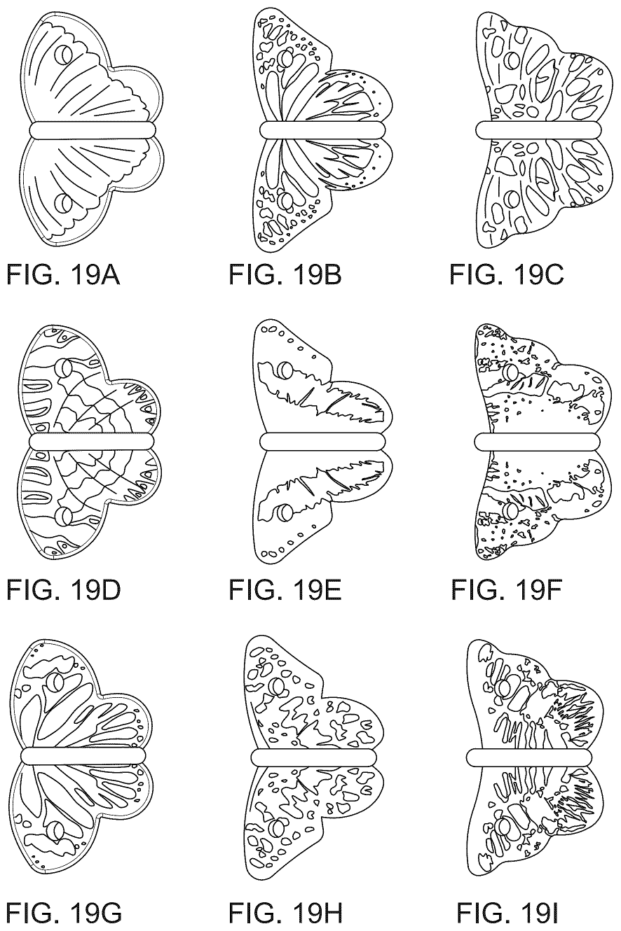

In one aspect, the handle 50 comprises a first width near a top 52 of the handle 50 and a second width near the bottom 53 of the handle 50. The first width is larger than the second width emulating a top or thorax portion of the butterfly while the bottom portion emulates the abdomen. In other aspects of the technology, the handle 50 comprises a thin protrusion rather than a bug body. In those aspects, if desired, the bug body is part of a printed pattern on the guard 30, rather than fully embodied in the handle 50. The thin protrusion is parallel with the bug body in some aspects. In others, the thin protrusion is perpendicular to the bug body. A top of the guard 30 is decorated with one of any number of different wing designs as can be seen in FIGS. 19A-19I.

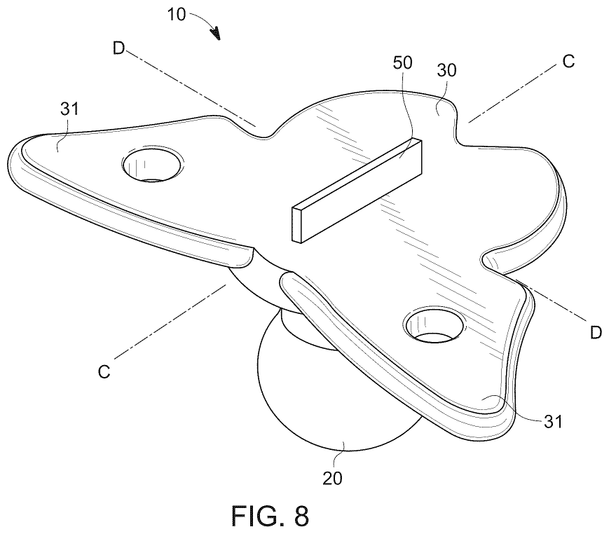

In one aspect of the technology, the shapes of the wings that form the guard 30 are symmetrical from left to right, but asymmetric from top to bottom. Meaning, about an imaginary axis C-C (see FIG. 8, for example) that is about the center of the pacifier from top to bottom, the shape of the wings are symmetrical. However, if an imaginary axis D-D were placed about the center of the pacifier from left to right, the wings are asymmetric. In another aspect of the technology, the handle 50 is symmetric about the imaginary axis C-C and the imaginary axis D-D.

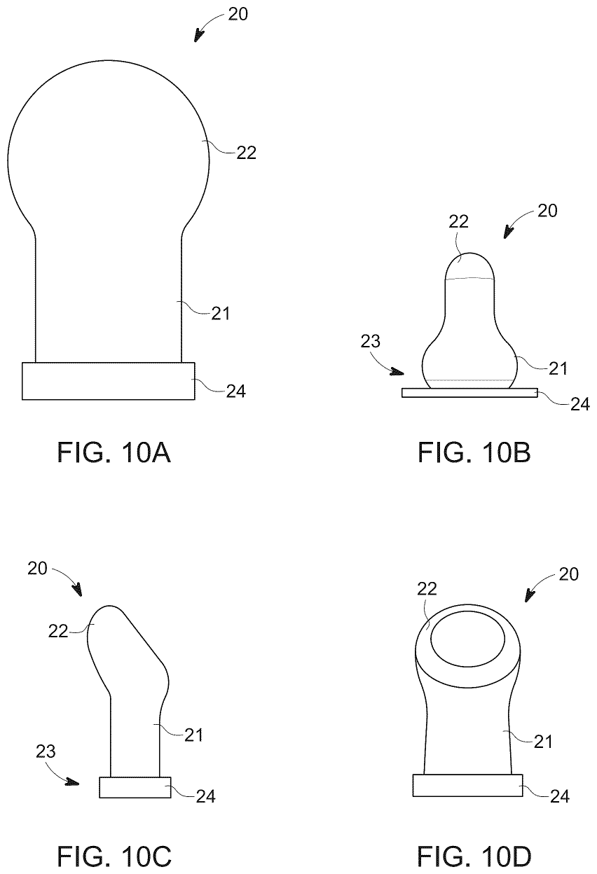

In one aspect of the technology, a bottom of the guard 30 comprises a protrusion extending slightly away from the bottom of the guard. The protrusion defines a space about a center portion of the guard intended to accommodate a portion of the nipple 20 therein. Referring generally to FIGS. 10a through 10d, in one aspect of the technology, the nipple 20 comprises rubber, latex, or silicone. The nipple is shaped with a neck 21 leading to a distal end 22. In one aspect, the distal end 22 of the nipple 20 has a greater circumference than the neck 21 (see, e.g., 22b), but in other aspects the neck 21 has a smaller circumference than the distal end 22 (see, e.g., 22a and 22c). The nipple 20 can comprise an orthodontic shape (22c and 2d) or a simple bulbous shape as suits a particular user. In one aspect of the technology, a proximal end 23 of the nipple 20 comprises an apron 24 that rests within the guard 30 to help secure the nipple 20 within the guard.

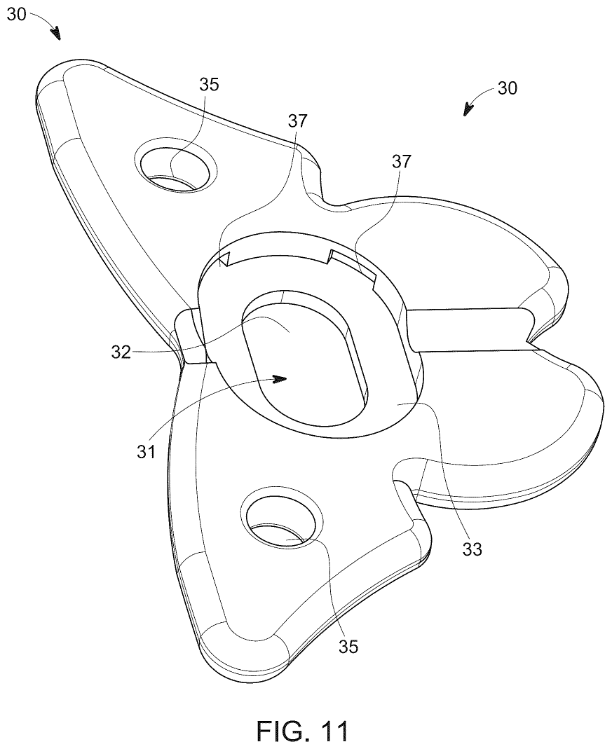

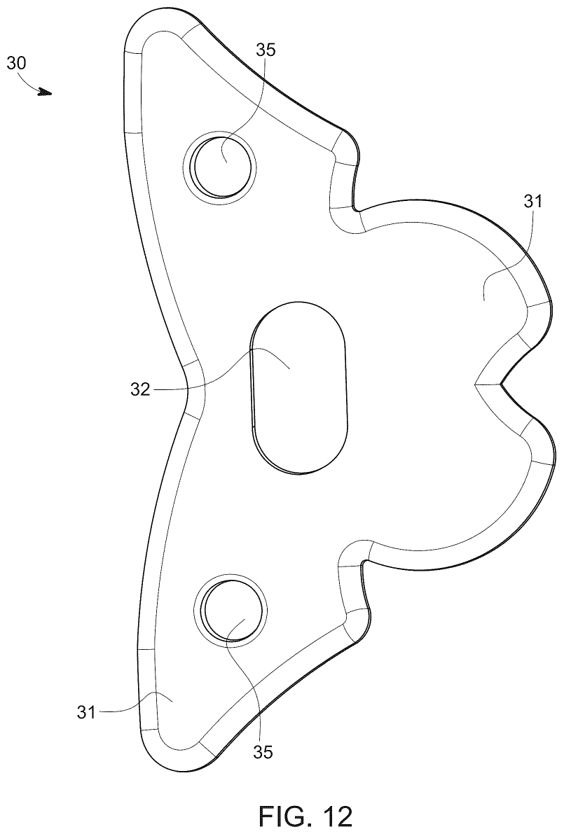

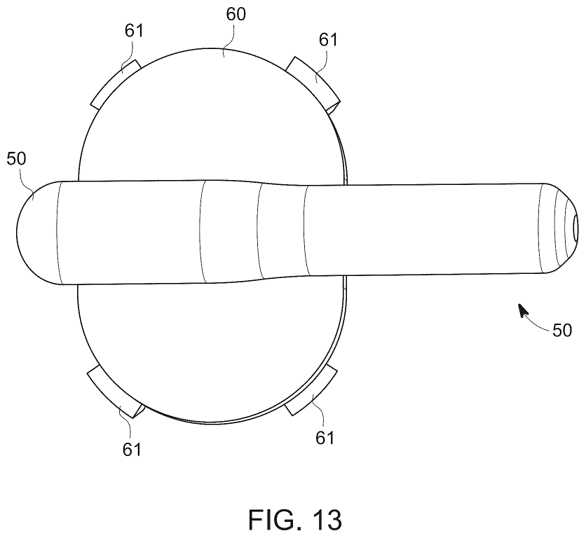

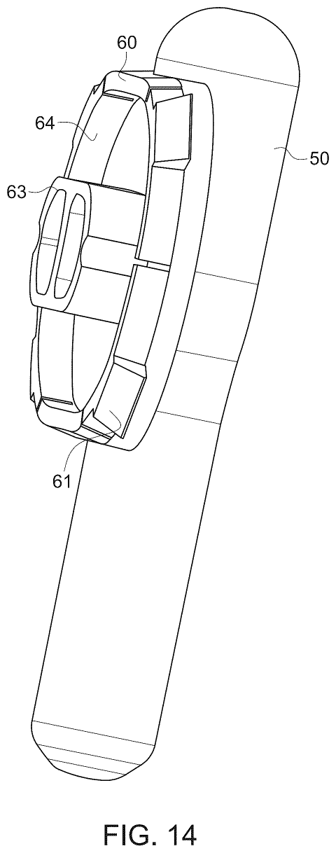

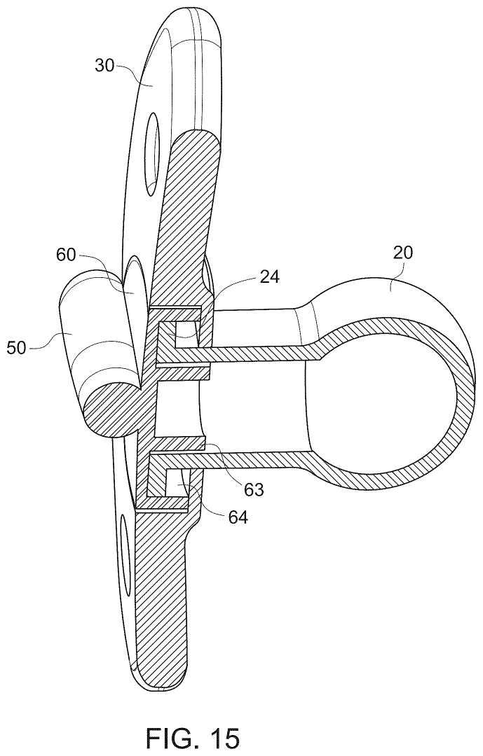

Referring generally to FIGS. 11-17, in one aspect of the technology, the guard 30 comprises a void where the apron 24 of the nipple 20 is seated. The void comprises an opening 32 about a ledge 33 where a top edge of the apron 24 rests. The handle 50 comprises a handle assembly comprising an oval, circular (or other shaped) tab 60 configured to press down on the apron 24 of the nipple 20 and secure the nipple 20 firmly within the guard 30.

In one aspect, the tab 60 is friction fit within the void. In another aspect, the tab 60 also comprises a plurality of secondary tabs 61 that mate with apertures 37 within the sides 63 of the void to secure the tab 60 within the void. In one aspect of the technology, once the tab 60 is pressed into or otherwise secured within the void, the tab is sonically welded or otherwise secured to the guard to create a continuous top about the area of the handle 50. A pair of holes 35 are disposed on opposing sides of the guard 30. In one aspect, once the handle assembly is secured about the guard 30, a wing pattern (or other design) is disposed about a face of the guard 30 to emulate a butterfly wing pattern (or other design). Different patterns may be used as suits a particular design.

In one aspect, a bottom side of the tab 60 comprises an insert 63 configured to be disposed within the nipple 20. The apron 24 is seated between the insert 63 and the inside walls 64 of tab 60. In this manner, the apron 24 is further secured within the guard 30.

In one aspect, the guard and handle comprise polycarbonate, polypropylene, silicone, or any thermoplastic elastomer or thermoset plastic. In one aspect, the nipple, guard, and handle can be molded through a heat injection or cold injection process, extruded, cast, or otherwise formed to create the desired shapes.

In yet another aspect of the technology, the handle 50 and the tab 60 are separately manufactured and separately disposed about the guard 30. For example, in one aspect, the tab 60 is pressed within the void as noted herein and the handle 50 is afterwards welded or otherwise secured to the top of the tab 60. In this manner, the entire guard 30 can be printed with a pattern (butterfly, moth, other insect or other things) before the handle 50 is secured to the top of the tab 60.

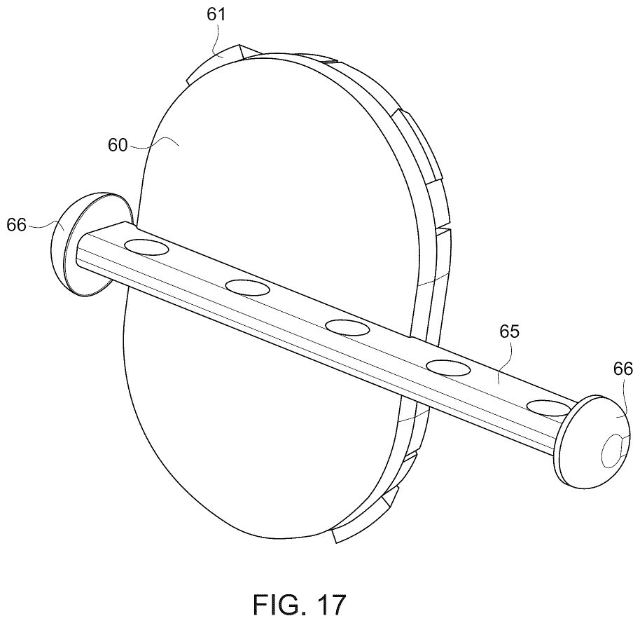

With reference to FIG. 17, in another aspect of the technology, the handle 50 is formed as part of the tab 60, but the handle 50 comprises a handle assembly with a skeleton 65 with opposing knobs 66. A material molded over the skeleton 65 between knobs 66 to form the handle 50. In one aspect of the technology, the overmold is formed from a more pliant or softer material that is easier to grasp with the fingers and remove from the baby's mouth.

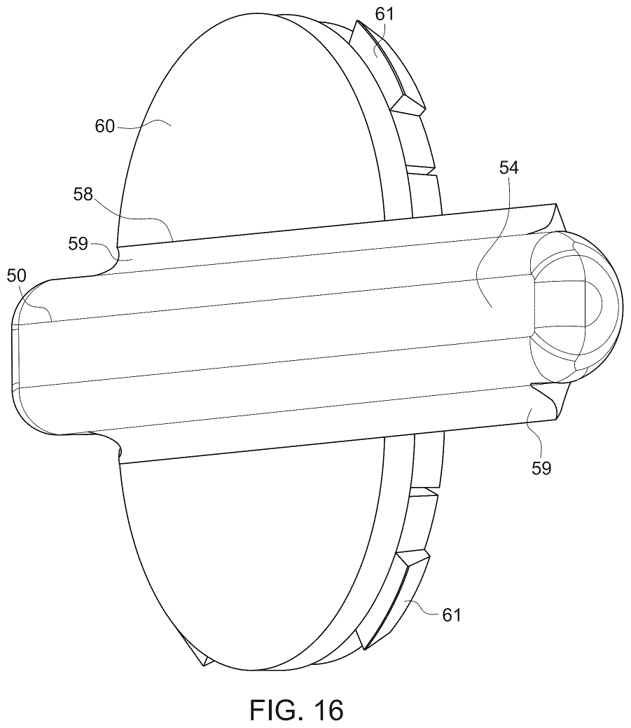

Referring generally to FIG. 16, in another aspect of the technology, the handle assembly is formed with handle 50 with tab 60. In this aspect, the elongate handle 50 has a substantially flat top 54 and an overall oval construction. At the point where the handle 50 meets the tab 60, the handle 50 curves into the tab 60. The curvature 59 is extended distally about the handle 50 so that the curved portion 59 of the handle 50 pairs with the face of guard 30.

In one aspect of the technology, the design disposed on top of the guard through one of numerous different processes including, but not limited to, UV printing, digital ink jet printing, screen printing, flexographic printing, pad printing, and laser printing. In any event, the printing process results in a product that may be placed within an infant's mouth safely.

While reference is made herein to a pacifier made from a plurality of pieces, it is contemplated herein that the pacifier with the nipple, guard, and handle may comprise a single unitary composition. Meaning, each of the nipple, guard, and handle are molded or otherwise constructed as a single product. The pacifier may be molded, extruded, cast, or injected as suits a particular application. In the instance where the pacifier is a single-piece construction, the wing pattern can be placed on the face of the guard and/or handle after the unit is constructed. In another aspect, however, the single-piece-constructed pacifier has the wing pattern integrally formed into the face during manufacturing of the single-piece unit.

Referring generally to FIG. 18, in one aspect of the technology, the pacifier is disposed in an improved package. The package comprises a rectangular opening having a plurality of opaque sides and bottom, though other shapes (i.e., triangular, oval, or circular) are contemplated for use as suits a particular desire. A top of the package comprises a transparent top. In one aspect, the pacifier rests on a package insert that holds the pacifier upright such that the guard is displayed through the transparent top. A top of the sides of the opaque package is higher than the pacifier as it rests within the package. In one aspect, the packaging insert comprises a white planar sheet folded to create two bottom pieces, two side pieces, and a single top. A hole is disposed in the top through which the nipple of the pacifier is inserted. In another aspect, the insert is folded and placed in the package such that the insert comprises a single bottom, two side pieces, and two top pieces. The two top pieces comprise a hole through which the nipple of the pacifier is inserted. Advantageously, the pacifier is presented to the user in the packaging as if it were a mounted insect within a display case. While a transparent top is referenced with opaque sides and bottom, it is also contemplated that the top may be opaque and the sides may be transparent to provide different effects for the display of the pacifier to the end user.

1. A pacifier, comprising:
a guard having a nipple disposed about the guard, the nipple extending downward from a bottom of the guard;
wherein the guard comprises a plurality of wings extending outward from an elongate handle disposed about a top of the guard; and
wherein the elongate handle comprises a protrusion extending upward from the top of the guard.

2. The pacifier of claim 1, wherein the elongate handle extends from at least a top of the guard to at least a bottom of the guard.

3. The pacifier of claim 1, wherein the wings comprise a top portion that extends outward laterally from the elongate handle a first distance and a bottom portion that extends outward laterally from the elongate handle a second distance.

4. The pacifier of claim 3, wherein the first distance is greater than the second distance.

5. The pacifier of claim 3, wherein the first distance is less than the second distance.

6. The pacifier of claim 1, wherein the wings comprise a top portion that extends above a top portion of the elongate handle in a longitudinal direction of the elongate handle.

7. The pacifier of claim 1, wherein the wings comprise a bottom portion that extends below a bottom portion of the elongate handle in a longitudinal direction of the elongate handle.

8. The pacifier of claim 1, wherein the wings comprise a first height and the elongate handle comprises a second height.

9. The pacifier of claim 8, wherein the first height is greater than the second height.

10. The pacifier of claim 8, wherein the first height is equivalent to the second height.

11. The pacifier of claim 8, wherein the first height is less than the second height.

12. A pacifier, comprising:
a nipple disposed about a guard and extending downward from a bottom of the guard, the guard comprising a plurality of opposing wings extending outward from an elongate handle;
wherein the wings comprise a curved upper portion and a curved bottom portion, the curved upper portion having a width that is greater than the curved bottom portion;
the elongate handle is disposed between opposing wings and comprises a protrusion extending at least from a top portion of the guard to at least a bottom portion of the guard.

13. The pacifier of claim 12, wherein the elongate handle comprises a handle assembly configured to mate with an opening within the guard.

14. The pacifier of claim 13 wherein the handle assembly comprises an oval formed with the elongate handle, the oval sized to approximate the shape of the opening within the guard.

15. A pacifier, comprising:
a nipple retained about a guard;
the guard comprising a top portion, a bottom portion, and an elongate handle;
wherein the top portion of the guard comprises opposing distal ends defining a maximum length of the top portion about a longitudinal length of the guard and wherein the bottom portion comprises opposing distal ends defining a maximum length of the bottom portion;
wherein the maximum length of the top portion is greater than the maximum length of the bottom portion;
wherein the elongate handle extends from near a top of the top portion of the guard to near a bottom of the bottom portion of the guard, the elongate handle comprising a longitudinal length that is normal to an axis extending from opposing distal ends of the top portion.

16. The pacifier of claim 15, wherein the handle is coupled to a handle assembly.

17. The pacifier of claim 16, wherein the handle assembly comprises the handle formed with a mating section configured to mate with a receiving section in the guard.

18. The pacifier of claim 17, wherein the nipple comprises an apron configured to be compressed between the mating section of the handle assembly and the receiving section of the guard.

19. The pacifier of claim 15, wherein the elongate handle protrudes above the top of the guard in a direction parallel to a longitudinal direction of the nipple a distance that is substantially the same as the thickness of the guard.

20. The pacifier of claim 15, wherein the elongate handle has a first width near a top of the handle and a second width near a bottom of the handle, the first width being greater than the second width.
